(19) United States
(12) Patent Application Publication
(10) Pub. No.: US 2002/0109676 A1
(43) Pub. Date: Aug. 15, 2002

(54) Device for data reception via radio signals in a motor vehicle

(76) Inventors: Werner Pochmuller, Hildesheim (DE); Rodolfo Mann Pelz, Hannover (DE); Thomas May, Wolfenbuettel (DE)

Correspondence Address: KENYON & KENYON, ONE BROADWAY, NEW YORK, NY, 10004, US

(21) Appl. No.: 10/026,087

(22) Filed: Dec. 12, 2001

(30) Foreign Application Priority Data
Dec. 28, 2000 (DE) 1 00 65 520.3-34

(51) Int. Cl. G09G 5/00

(52) U.S. Cl. 345/169

(57) ABSTRACT

A device for receiving data via radio signals in a motor vehicle, where a single operation of an input means putting the device in a state, stored in the memory, for playback of the data. As a result, when confronted with an apparently hopeless situation, a user in a motor vehicle, in the simplest of operations and without being distracted from driving activities, is able to return the device to a state where it may be optimally utilized. Various input devices are possible here, such as a pushbutton, a remote control or a microphone. The state may be characterized by various selection options, including resumption of data reception from a service, resumption of a service used previously, returning to a portal of a service provider or restarting the device, in which case the restart may be performed either through hardware or software. A pushbutton may cause various states of the device, depending on the length of time of operation of the pushbutton.

### BACKGROUND INFORMATION

It is known that car radios may be used as radio receivers for data reception in a motor vehicle, the car radio having a processor which has a memory, an input device and a display for displaying the data received.

### SUMMARY OF THE INVENTION

The device according to the present invention for data reception via radio signals in a motor vehicle has the advantage that in the event of a fault or another seemingly hopeless situation, the driver may return to a defined state of the device according to the present invention by a single operation of an input means, and the driver may then use the device optimally again. Since a driver in a motor vehicle is very busy due to his driving activity, the driver would also benefit from such a simple operating option and is able to perform a simple operation of the device according to the present invention with increased safety despite an increased data service offering. This operation is preferably accomplished by depressing a key or by a voice command. Situations requiring such a measure would include, for example, getting lost in a data service offering, failure of a service to respond due to trouble in data reception or lack of terminal compatibility with the selected service, faulty software applications that fail to respond and operating system errors. Such situations occur in particular with problems such as conflicts in accessing the memory. According to the present invention, the driver is able to return to a defined state which may be selected by the driver himself, by a simple operation of the input means, and then the device according to the present invention may be used again as defined above.

It is especially advantageous for the input means to be designed either as a pushbutton on the device or as a remote control, the remote control then being attached to the steering wheel, for example, to transmit input data to the device according to the present invention over an infrared transmission link. Remote control has in particular the advantage that the driver need not take his hands off the steering wheel.

In addition, it is advantageous that the input means is designed as a microphone, so that the driver need not make any manual movements to place the device according to the present invention into a defined state. The device according to the present invention then has the microphone and suitable speech analysis, performed either in a processor provided with the microphone or in the main processor of the device according to the present invention.

It is also advantageous that when the driver reaches the desired state by operating the input means, he is offered at least one selection option, from which he selects one. A first selection option here is to resume data reception from a service, a second selection option is to resume a service used previously, a third selection option is to return to a selected portal of a service provider and the fourth selection option is to restart the device.

It is especially advantageous that the portal is either already stipulated in the device or may be stipulated by the user.

It is also advantageous that the restart may either be executed through software, in which case the software is restarted, or in a more unfavorable case, the restart may also be performed through the hardware, in which case the entire device is restarted again.

Finally, it is also advantageous that a different state is selected when the driver keeps the button depressed for a certain period of time than when the driver holds the button down only briefly. For example, a return to a portal may be brought about by depressing the button briefly and a restart of the device according to the present invention may be brought about by depressing it for a longer period of time.

### BRIEF DESCRIPTION OF THE DRAWINGS

FIG. 1 shows a block diagram of the device according to the present invention.

FIG. 2 shows a first flow chart of the operation of the device according to the present invention.

FIG. 3 shows a second flow chart of the operation of the device according to the present invention.

### DETAILED DESCRIPTION

Due to the increasing integration of more and more infotainment components into the motor vehicle, and thus the associated development of the motor vehicle into an Internet node, there may be problems such as those already encountered with other software-based systems. Such problems may include a situation from which the user cannot escape by a conventional operation, e.g., software no longer responding or a problem in the operating system. Due to ever more complex services, it may also occur that the user gets lost in a service offering. According to the present invention, such a device for data reception in a motor vehicle is provided, having input means to return to a defined state in such situations so that then the device is able to be used optimally again.

Data reception of such data to a motor vehicle may be performed by different radio transmission systems. Broadband digital radio systems in particular are especially suitable for this purpose. These include DAB (Digital Audio Broadcasting), DVB (Digital Video Broadcasting) and DRM (Digital Radio Mondial), which because of their broadband property and data structure also permit transmission of multimedia data, which are then displayed in the motor vehicle, in addition to transmission of strictly radio audio services. Such data includes in particular Internet web pages containing video data streams, images, graphics, text and animation, such types of data also being transmissible in data files other than Internet web pages. Such broadband digital radio transmission methods may also be satellite supported.

In addition to the radio broadcast methods, mobile wireless methods are also suitable for transmitting such multimedia data. These are bidirectional transmission methods, such as GSM (global system for mobile communication), UMTS (universal mobile telecommunication system) or locally limited, local radio-based networks based on Bluetooth or another local network such as LAN (local area network). These bidirectional radio transmission systems have in particular the advantage that specific data retrieval is possible. In a refinement, it is also possible for broadband digital radio broadcast transmission methods to be combined with bidirectional radio transmission methods to receive data over broadband digital radio broadcast transmission methods, while bidirectional radio transmission methods are used only for retrieval of data. This has the advantage that the retrieval, which is generally only a very short communication, is sent by the narrowband bidirectional radio transmission method, while the useful data, representing a much larger volume of data than the strict data request, is transmitted by the broadband digital radio broadcast transmission method, which is usually received at no cost.

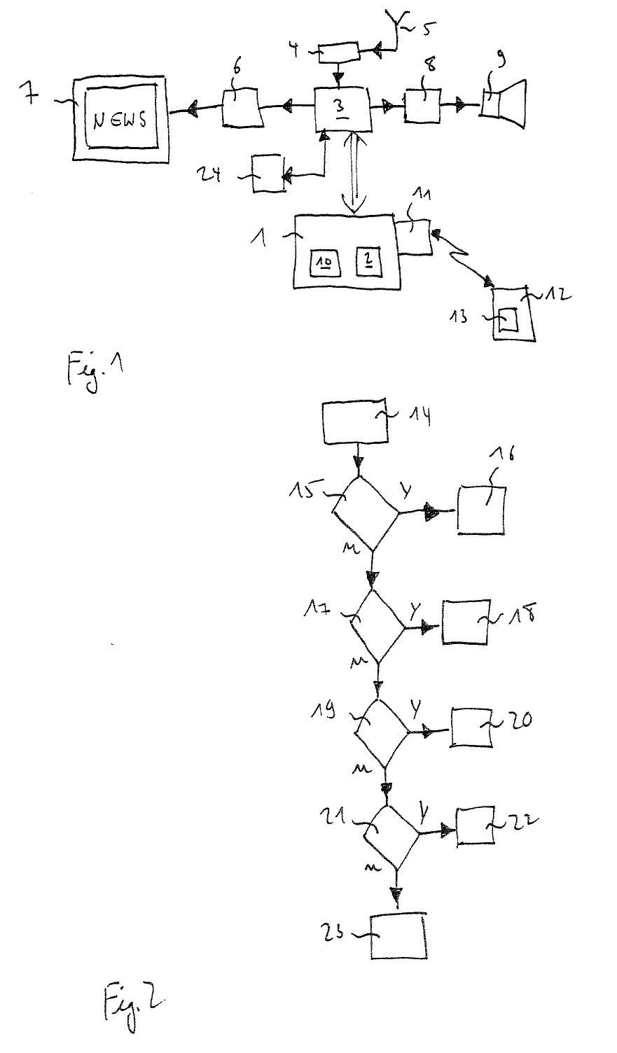

FIG. 1 shows as a block diagram the device according to the present invention. An input device 1 has a pushbutton 2, microphone 10 and an infrared transceiver device 11. Instead of infrared, radio transmission systems for the local range such as Bluetooth are also possible. Input device 1 is connected to a processor 3 over a data input/output. Processor 3 is connected to a memory 24 over a second data input/output. Processor 3 is connected to a high-frequency slave station 4 over a data input. Processor 3 is connected to a signal processing unit 6 over a first data output. Processor 3 is connected to an audio amplifier 8 over an analog output.

An antenna 5 is connected to one input of high-frequency slave station 4. A display 7 is connected to a data output of signal processing unit 6. As an alternative, it may also be an analog output, if signal processing unit 6 performs a digital-to-analog conversion. A loudspeaker 9 is connected to an output of audio amplifier 8. Transceiver device 11 is connected to a remote control 12 over a free-space infrared transmission link. Remote control 12 has an input field 13.

A user makes entries on input device 1, either through voice commands picked up by microphone 10 or by manual input via pushbutton 2 or remote control 12 in input field 13, and these entries are transmitted by input device 1 to processor 3. Depending on these entries, processor 3 brings data for playback on display 7 and/or loudspeaker 9. The device according to the present invention receives the data over antenna 5 and high-frequency slave station 4, designed for receiving broadband digital radio signals, such as DAB. High-frequency slave station 4 also performs filtering, amplification and downmixing of the received signals as well as digitization. The digital data is then transmitted from high-frequency slave station 4 to processor 3 which performs decoding and reformatting of the received data. The data is then optionally stored in memory 24 or played back immediately via display 7 and/or loudspeaker 9. If processor 3 transmits data to signal processing unit 6, signal processing unit 6 then processes the data for display 7 and/or for audio amplifier 4 for playback. The audio data transmitted as analog data from processor 3 to audio amplifier 8 is only amplified by audio amplifier 8 to then be played back by loudspeaker 9. Assigned in this context to processor 3 is a digital-to-analog converter, so that processor 3 may convert digital audio data to analog audio signals.

High-frequency slave station 4 may be further embodied so that it also functions as a transceiver to retrieve data directly from a remote central server over a bidirectional radio transmission method, for example. Combinations of a radio receiver and a mobile wireless box are also possible here.

If a situation arises in which the user of the device according to the present invention gets lost in a data service offering and no longer knows how to proceed, the user then operates either button 2 or input field 13 on remote control 12 or he delivers a special voice command which is picked up by microphone 10, so that the device according to the present invention is able to jump back to a previously defined state. The defined state is stored in memory 24 and is then loaded from memory 24 by processor 3 by operation of the proper input means on input device 1. This state is either jumping back to a portal of a data service provider, a restart, or resumption of a data service.

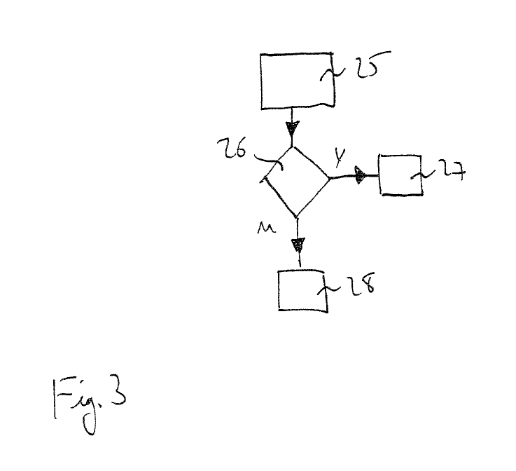

FIG. 2 shows a flow chart illustrating how such a jump back may take place. In step 14 it is ascertained that either one has gotten lost in a service offering or there is a fault scenario, such as an operating system error or an application failing to respond, or there is an error in data reception. In step 15, a check is performed to determine whether data reception of the selected service that was used last may be resumed. If this is the case, then in step 16 this data service is resumed. If this is not the case, then in step 17 a check is performed to determine whether a service used previously, where data reception was possible, should be resumed. If this is the case, then in step 18, this previously used service is resumed. If this is not the case, then in step 19, a check is performed to determine whether to return to a selected portal of a service provider to thereby allow the user to select certain data. If this is the case, then in step 20 there is a jump back to this portal. If this is not the case, then in step 21 a check is performed to determine which type of restart is necessary then. In particular, a check is performed in step 21 to determine whether a software restart has been selected. If this is the case, then this software is restarted in step 22. If this is not the case, in step 23 the entire device is restarted, i.e., a reset.

The selection options described above may be influenced or selected by the user. To do so, the user uses input device 1. It may also happen that only one or two or three of the four selection options given here are carried out according to the present invention, for example, only a restart of the device is possible or there is a choice between a restart and jumping back to a portal of a service provider.

FIG. 3 shows in a second flow chart how different states may be achieved by operating pushbutton 2 for different periods of time. The pushbutton is depressed in step 25. In step 26, a check is performed to determine whether pushbutton 2 has been released again up to a given time; if this is the case, then in step 27 the first selection option, e.g., jumping back to a portal is performed; if this is not the case, then pushbutton 2 is still depressed and a restart of the device according to the present invention has been selected by the user. The input device has appropriate means for this, such as a counter for analyzing the period of time during which the pushbutton is depressed.

Such different states may also be reached through different voice commands. For example, through the voice command “restart” it is possible for the device to perform a restart. For example, if the user issues the “home” command, this causes a jump back to a portal of a service provider established previously. The device according to the present invention thus makes it possible for a driver to reset his device according to the present invention back in a previously established state through extremely simple voice commands, so that the device may be utilized optimally again.

What is claimed is:

1. A device for receiving data via radio signals in a motor vehicle, comprising:
an input device;
a radio receiver for receiving data;
a processor for processing the data;
a memory; and
a display for displaying the processed data,
wherein the input device, when operated once, in the event of a fault, puts the device in a state defined in the memory for playing back the data.

2. The device according to claim 1, wherein the input device includes at least one pushbutton on the device.

3. The device according to claim 1, wherein the input device includes a remote control.

4. The device according to claim 1, wherein the input device includes a microphone.

5. The device according to claim 1, wherein the state leads to the display of selection options, one of which is to be selected.

6. The device according to claim 5, wherein the selection options include:
a first selection option to resume data reception from a service;
a second selection option to resume a service used previously;
a third selection option to return to a selected portal of a service provider; and
a fourth selection option to restart the device.

7. The device according to claim 6, wherein the portal is stipulated by a user of the device.

8. The device according to claim 6, wherein the portal is stipulated in the device.

9. The device according to claim 6, wherein the restart is performed through software.

10. The device according to claim 6, wherein the restart is performed through hardware.

11. The device according to claim 2, wherein the pushbutton causes various states of the device after operation for different periods of time.
